(19) United States
(12) Patent Application Publication
(10) Pub. No.: US 2026/0205548 A1
(43) Pub. Date: Jul. 16, 2026

(54) IMAGE READING APPARATUS AND IMAGE FORMING APPARATUS

(71) Applicant: CANON KABUSHIKI KAISHA, Tokyo (JP)

(72) Inventors: YOSHIMASA BANDO, Tokyo (JP); AKIRA MATSUMOTO, Ibaraki (JP)

(21) Appl. No.: 19/445,307

(22) Filed: Jan. 9, 2026

(30) Foreign Application Priority Data
Jan. 14, 2025 (JP) 2025-004746

(51) Int. Cl. H04N 1/00; G03G 15/22; H04N 1/028

(52) U.S. Cl. CPC H04N 1/00557; G03G 15/228; H04N 1/00559; H04N 1/02815

(57) ABSTRACT

An image reading apparatus includes a casing, a transparent plate, an image reading unit, a cable, a guide member, and a securing member. The cable includes a first terminal portion connected to a moving unit and a second terminal portion connected to a board which is arranged outside an accommodating space of the image reading unit. The guide member is mounted to the casing and configured to guide the cable that deforms in an interior of the accommodating space with movement of the moving unit. A portion between the first terminal portion and the second terminal portion in the cable is secured to the securing member. The securing member is mounted to the casing in the interior of the accommodating space at a position where a distance from the securing member to the opening portion is shorter than a distance between the guide member and the opening portion.

### BACKGROUND

### Field of the Technology

The present disclosure relates to an image reading apparatus for reading an image of a document and to an image forming apparatus to which this image reading apparatus is applied.

### Description of the Related Art

Japanese Patent Laid-Open No. 2021-83013 discusses a guide member that restricts the posture and a position of a flexible flat cable (“cable”) mounted in an interior of a casing of an image reading apparatus. In this image reading apparatus, the guide member is disposed to hold the posture and the position of the cable in a desired state, to thereby suppress entanglement of the cable with an image reading unit due to improper posture.

However, in the image reading apparatus discussed in Japanese Patent Laid-Open No. 2021-83013, when mounting the cable, it is necessary to perform an operation of securing the cable to the guide member, which has been mounted to the casing, while looking into the interior of the casing. Thus, workability is difficult and accuracy of mounting the cable may be impaired.

### SUMMARY

The present disclosure provides an image reading apparatus and an image forming apparatus that improves mounting accuracy of a cable with respect to a casing.

An aspect of the present disclosure provides an image reading apparatus that includes a casing including an opening portion; a transparent plate mounted to the casing; a moving unit accommodated in an accommodating space formed by the casing and the transparent plate and configured to move in a sub-scanning direction to read an image on or adjacent to the transparent plate by performing a scan in a main scanning direction; a cable including a first terminal portion connected to the moving unit and a second terminal portion connected to a board arranged outside the accommodating space, the cable being arranged to pass through the opening portion; a guide member mounted to the casing and configured to guide the cable that deforms in an interior of the accommodating space with movement of the moving unit, and a securing member. The cable is secured to the securing member between the first terminal portion and the second terminal portion. The securing member is mounted to the casing in the interior of the accommodating space at a distance from the securing member that is shorter than a distance between the guide member and the opening portion.

Another aspect of the present disclosure provides an image forming apparatus includes the image reading apparatus, and an image forming unit configured to form an image on a sheet.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view illustrating an image forming apparatus according to a first embodiment.

FIG. 2 is a perspective view illustrating an image reading apparatus according to the first embodiment.

FIG. 3A is a perspective view illustrating an A1 portion of FIG. 2 in an enlarged form.

FIG. 3B is a plan view illustrating positional relationships among a guide member, a securing member, and an opening portion.

FIG. 4 is a plan view illustrating the image reading apparatus according to the first embodiment.

FIG. 5 is a cross-sectional view illustrating the image reading apparatus according to the first embodiment.

FIG. 6A is a plan view illustrating a cable according to the first embodiment, illustrated in a state prior to bending.

FIG. 6B is a plan view illustrating the cable according to the first embodiment, illustrated in a state subsequent to the bending.

FIG. 7 is a perspective view illustrating the cable and the securing member according to the first embodiment.

FIG. 8A is a perspective view illustrating the securing member according to the first embodiment, viewed from the back.

FIG. 8B is a perspective view illustrating the securing member according to the first embodiment, in a state of being mounted to a casing, when viewed from the back.

FIG. 9A is a perspective view illustrating the guide member according to the first embodiment.

FIG. 9B is a perspective view illustrating a guide member according to a variant example.

FIG. 10 is a perspective view illustrating a regulatory member according to the first embodiment.

FIG. 11 is a perspective view illustrating an image reading apparatus according to a second embodiment.

FIG. 12 is a perspective view illustrating a cable and a securing member according to the second embodiment.

FIG. 13 is a cross-sectional view illustrating an image reading apparatus according to a third embodiment.

FIG. 14 is a cross-sectional view illustrating an image reading apparatus according to a fourth embodiment.

### DESCRIPTION OF THE EMBODIMENTS

### First Embodiment

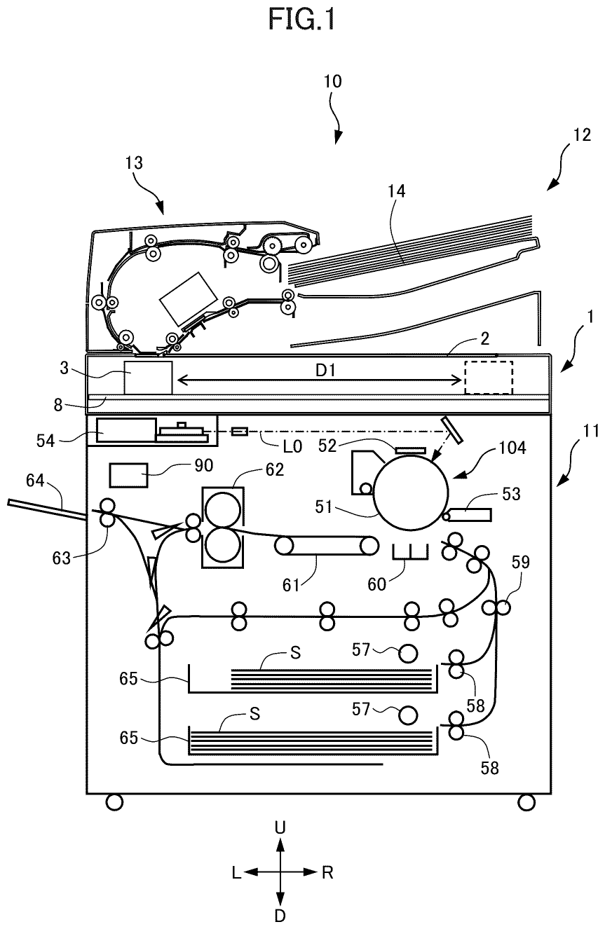

Hereinafter, making reference to FIGS. 1 to 10, a first embodiment will be described. In this embodiment, an example will be described of an image forming apparatus 10 of an electrophotographic system. Herein, document and sheet refer to a recording material including paper such as plain paper and coated paper, a recording material of a special shape such as an envelope and index paper, a plastic film such as a sheet for an overhead projector (OHP), and cloth. In addition, in this embodiment, when viewed by a user operating an operation panel of the image forming apparatus 10, the right-hand side may be referred to as a rightward direction R, the left-hand side may be referred to as a leftward direction L, the upper side may be referred to as an upward direction U, the lower side may be referred to as a downward direction D, a user side may be referred to as a frontward direction F, and the back side may be referred to as a backward direction B, as annotated in FIGS. 1-5, 11, and 13-14. In addition, in this embodiment, a left-right direction may be referred to as a sub-scanning direction D1 and a front-back direction may be referred to as a main scanning direction D2.

### Image Forming Apparatus

FIG. 1 is a schematic cross-sectional view illustrating the image forming apparatus 10. The image forming apparatus 10 includes an apparatus body 11 incorporating an image forming unit 104 that forms an image on a sheet S, and an image reading module 12 that reads the image of a document. The image forming apparatus 10 includes a controller board 90 (control unit), serving as an electronic board for executing various controls such as image processing and communication with external devices. An image reading unit 3, described below, of the image reading module 12 and the controller board 90 are electrically connected, and the image processing for converting the document image, read by the image reading unit 3, into image data is executed by an electronic component mounted on the controller board 90. In addition, image processing for generating image data based on an image input from external devices is performed by an electronic component mounted on the controller board 90.

### Apparatus Body

An image forming operation in the apparatus body 11 will be described. When forming the image, an image formation job signal is input to a central processing unit (CPU) mounted on the controller board 90. Thereby, the sheet S stacked and stored in sheet cassettes 65 is sent to a transfer portion formed by a photosensitive drum 51 and a transfer unit 60 by means of pickup rollers 57, sheet feed roller pairs 58, and a conveyance roller pair 59.

The image forming unit 104 of the apparatus body 11 forms the image by transferring a toner image onto the sheet S, and the image forming unit 104 includes the photosensitive drum 51, a charge unit 52, a developing unit 53, the transfer unit 60, and a laser scanner 54. In the image forming unit 104, a surface of the photosensitive drum 51 is charged by the charge unit 52. In accordance with the image data of the document read by the image reading module 12, or the image data received from an external personal computer (PC), the laser scanner 54 irradiates the surface of the photosensitive drum 51 with laser light L0. Thus, an electrostatic latent image is formed on the surface of the photosensitive drum 51. Toner is adhered to the electrostatic latent image formed on the surface of the photosensitive drum 51 by the developing unit 53, and the toner image is formed on the surface of the photosensitive drum 51.

The toner image formed on the surface of the photosensitive drum 51 is transferred onto the sheet S by applying a transfer bias to the transfer unit 60. The sheet S onto which the toner image has been transferred is conveyed to a fixing unit 62 by a conveyance belt 61. In the fixing unit 62, a heating and pressurizing process is provided, and, thereby, the toner image borne on the sheet S is fixed. The toner image fixed on the sheet S is discharged to a sheet discharge tray 64 by a sheet discharge roller pair 63.

### Image Reading Unit

The image reading module 12 is disposed on top of the apparatus body 11. The image reading module 12 includes an image reading apparatus 1 and an automatic document feeder (ADF) 13. In a case of reading the image of the document using the ADF 13, the user stacks the document on a document tray 14, and issues a document reading instruction through an operation unit. Thereby, the ADF 13 reads the image of the document while automatically conveying the document. In a case of reading the image of the document using the image reading apparatus 1, the user places the document on a platen glass 2, and issues the document reading instruction through the operation unit. Thereby, the image reading unit 3 reads the image of the document while moving in the sub-scanning direction D1. The ADF 13 is pivotably supported through a hinge, with respect to the image reading apparatus 1, and, by pivoting to open the ADF 13 upward, the user can access the platen glass 2 of the image reading apparatus 1.

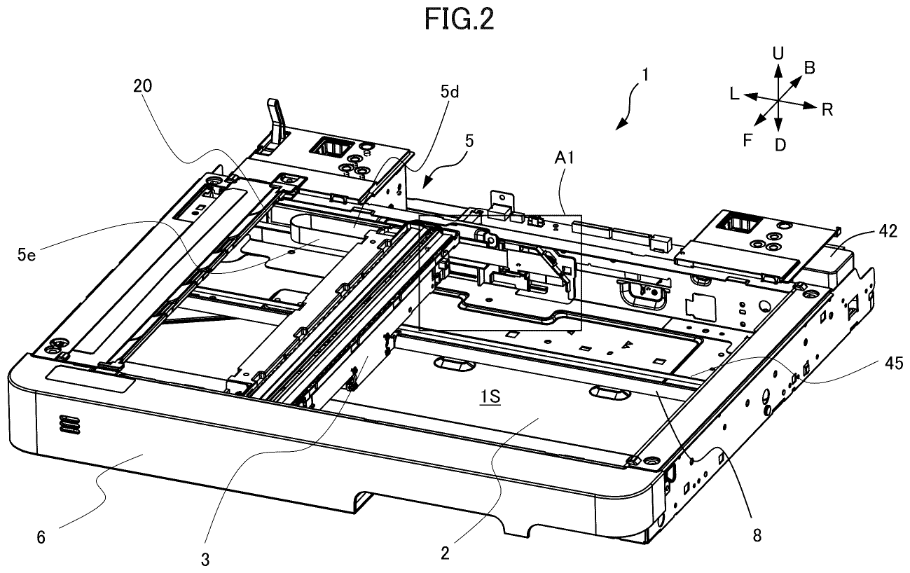

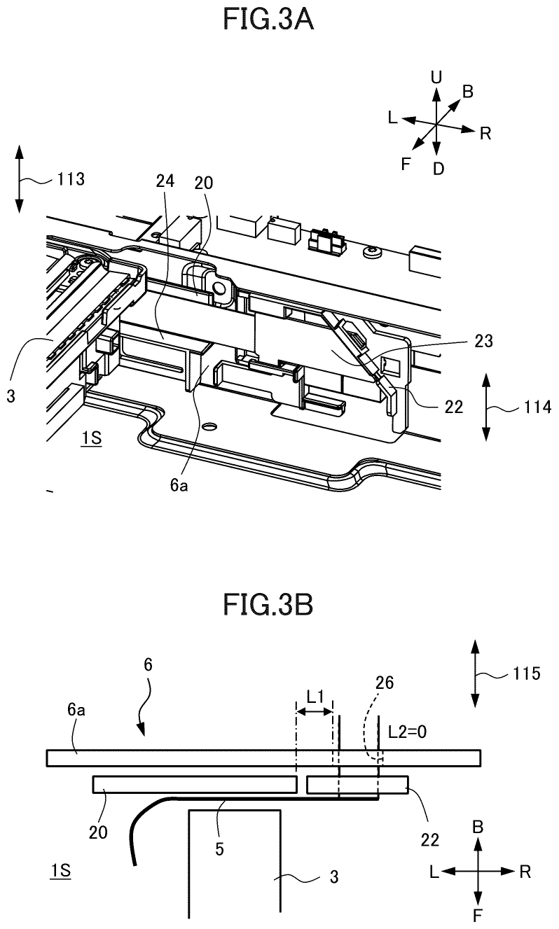

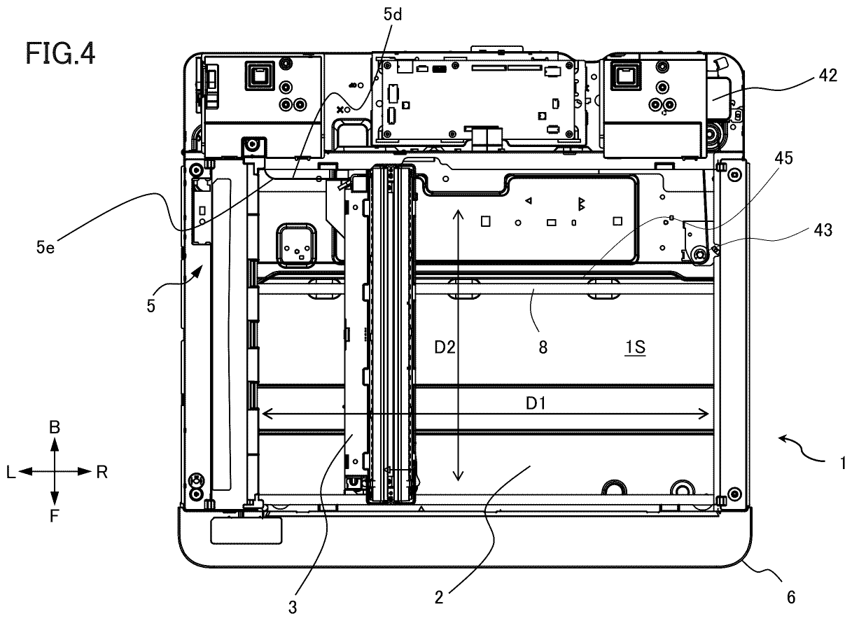

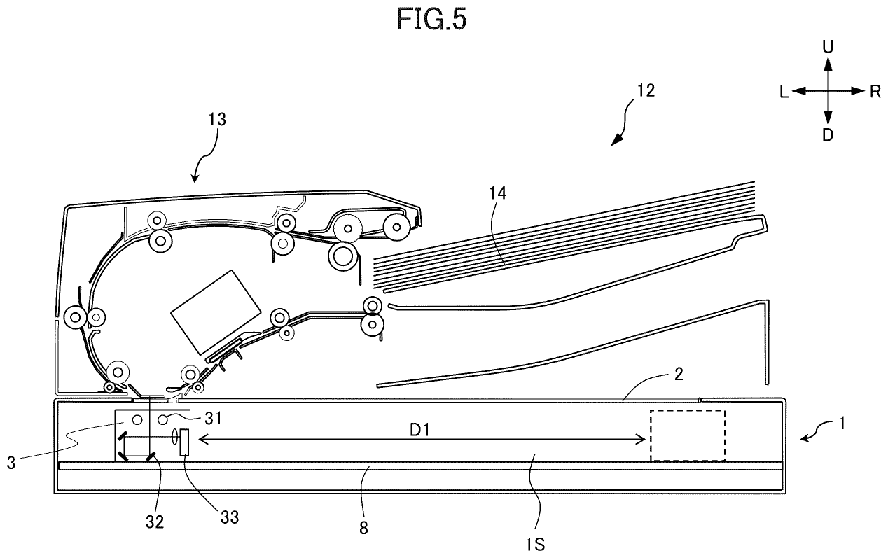

Next, a configuration of the image reading apparatus 1 will be described. FIG. 2 is a perspective view illustrating the image reading apparatus 1. FIG. 3A is an enlarged diagram illustrating an A1 portion of FIG. 2. FIG. 4 is a plan view illustrating the image reading apparatus 1. FIG. 5 is a schematic cross-sectional view illustrating the image reading apparatus 1. As illustrated in FIGS. 2 to 4, the platen glass 2, on which the document is placed, is fitted on an upper surface portion of a casing 6, made of metal, in the image reading apparatus 1. The platen glass 2 is a transparent rectangular glass plate, and is arranged such that an upper surface, on which the document is placed, extends in a horizontal direction 111. That is, the platen glass 2 is mounted to the casing 6, and is an example of a transparent plate on which the document is placed. With the platen glass 2, the casing 6 forms an accommodating space 1S that accommodates the image reading unit 3. Hereinafter, an interior of this accommodating space 1S may be referred to as an interior of the casing 6, and an exterior of this casing 6 may be referred to as an exterior of the casing 6. While, in this embodiment, the casing 6 is made of metal, it is not limited to this, and, for example, the casing 6 may also be made of resin.

In the accommodating space 1S of the casing 6, the image reading unit 3 that reads the image of the document placed on the upper surface of the platen glass 2 is accommodated. In this embodiment, the image reading unit 3 is constituted by a one-box reduction optical unit. That is, the image reding unit 3 includes a light emitting element 31 that irradiates light to the document on the platen glass 2, a mirror portion 32 that reflects reflected light reflected from the document, and a light receiving element 33 that receives reflected light from the mirror portion 32 and converts it into an electrical signal. The mirror portion 32 includes a plurality of mirrors. The image reading unit 3 performs a scan in the main scanning direction D2 such that, by irradiating the light from the light emitting element 31 with respect to the document, the light receiving element 33 receives the reflected light via the mirror portion 32 and a lens, and converts it into an electrical signal. The light receiving element 33 is constituted by, for example, a charge-coupled device (CCD). The image reading unit 3 moves in the interior of the accommodating space 1S, which is formed by the casing 6 and the platen glass 2, along the sub-scanning direction D1. In this embodiment, the image reading unit 3 itself constitutes an example of a moving unit that moves in the sub-scanning direction D1, and the light emitting and receiving elements 31 and 33 both are mounted to the moving unit.

In the interior of the casing 6, a guide shaft 8 extending in the sub-scanning direction D1 (left-right direction) of the image reading unit 3 is disposed. The image reading unit 3 is loosely and movably fitted to the guide shaft 8. In the interior of the casing 6, a motor 42, a drive gear affixed to a rotational shaft of the motor 42, a driven gear engaged with the drive gear, and a pulley 43 that is arranged coaxially with the driven gear and rotates integrally with the driven gear are disposed. In the interior of the casing 6, a pulley disposed to form a pair with the pulley 43 in the sub-scanning direction D1, and a rotary belt 45 suspended between these pulleys are disposed. The rotary belt 45 is connected to the image reading unit 3.

When the motor 42 is driven through an instruction of the CPU mounted on the controller board 90, a driving force of the motor 42 is transmitted via the drive gear, the driven gear, and the pulley 43 to the rotary belt 45, and the rotary belt 45 performs circulating movement. With the circulating movement of the rotary belt 45, the image reading unit 3 connected to the rotary belt 45 moves toward the sub-scanning direction D1 while the movement is being guided by the guide shaft 8. By continuously scanning in the main scanning direction D2 utilizing the light emitting and receiving elements 31 and 33 while moving in the sub-scanning direction D1, the image reading unit 3 reads the image of the document placed on the platen glass 2.

The electrical signal generated by the light receiving element 33 of the image reading unit 3 is transmitted via a cable 5 to the controller board (control board) 90 disposed on a side of the apparatus body 11 of the image forming apparatus 10. The image processing is performed by an electronic component mounted on the controller board 90.

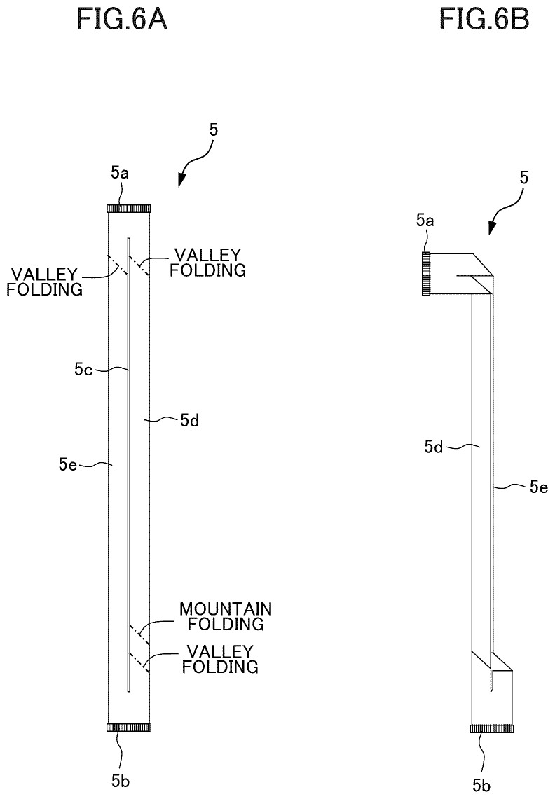

FIGS. 6A and 6B are plan views illustrating the cable 5. FIG. 6A illustrates a state prior to assembly of the cable 5, and FIG. 6B illustrates a state during the assembly. As illustrated in FIG. 6A, the cable 5 is constituted by a flexible flat cable having flexibility and a flat configuration. The cable 5 includes a first terminal portion 5a and a second terminal portion 5b. The first terminal portion 5a is connected to the image reading unit 3. The second terminal portion 5b is connected, at the exterior of the casing 6, to the controller board 90, which is an example of a board transmitting an electrical signal to and from the image reading unit 3. In this embodiment, the cable 5 is bent as illustrated in FIG. 6B. However, the present disclosure is not so limited, and a bending manner may be appropriately modified in accordance with the arrangement of the controller board 90 of the image reading apparatus 1.

In the cable 5, a slit 5c extending in a longitudinal direction of the cable 5 is formed on a side closer to a center portion in the longitudinal direction than the first and second terminal portions 5a and 5b, and is disposed adjacent to the center in a width direction 112 of the cable 5. The cable 5 is configured to be a single cable at both end portions in the longitudinal direction, and, in a portion in which the slit is formed, is divided into two cables: an inner cable 5d (first portion) and an outer cable 5e (second portion). That is, the cable 5 includes a plurality of conductor wires including a first conductor wire and a second conductor wire that electrically connect the first and second terminal portions 5a and 5b, and the inner and outer cables 5d and 5e respectively include the first and second conductor wires. In addition, the cable 5 includes the slit 5c disposed between the inner and outer cables 5d and 5e.

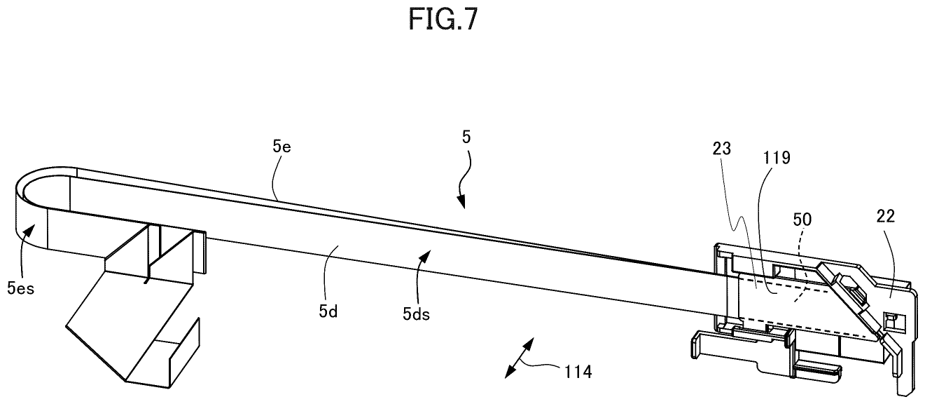

The inner and outer cables 5d and 5e are configured to overlap in their thickness direction 114 through mountain folding or valley folding. That is, the cable 5 is bent at the slit 5c as a center, and at least portions of the inner and outer cables 5d and 5e are overlapped when viewed in the thickness direction 114 of the cable 5. A conductor is not present at a position at which the slit 5c is formed. By overlapping such wide cables as described above, it is possible to increase an amount of data that the cable 5 can transmit, while reducing the space occupied by the cable 5; thereby, it is possible to achieve the miniaturization of the image reading apparatus 1. In this embodiment, as illustrated in FIG. 7, the cable 5 has a flat configuration including a first surface 5es and a second surface 5ds on an opposite side of the first surface 5es. Then, the cable 5 is arranged by aligning a width direction 112 of the first and second surfaces 5es and 5ds with a vertical direction 113.

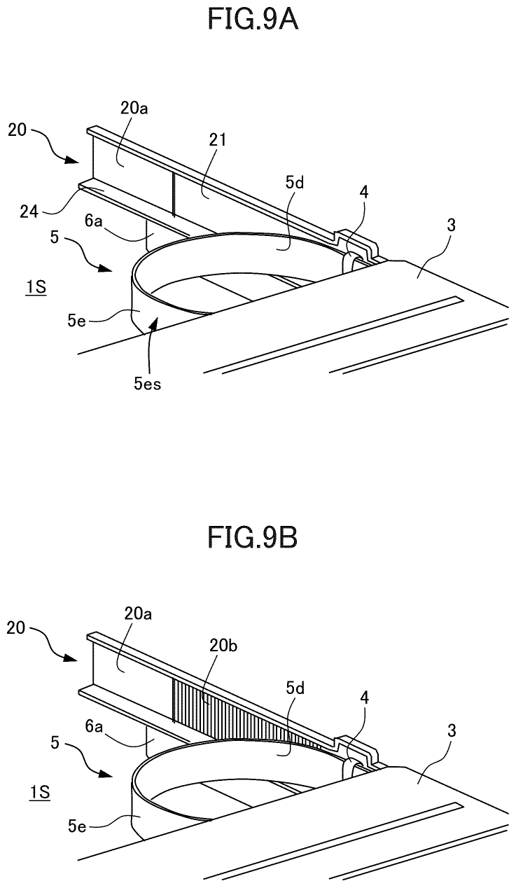

As illustrated in FIGS. 3A and 3B, a guide member 20 restricting the movement of the cable 5 in the width direction 112 and a securing member 22 securing the cable 5 are disposed on a side wall 6a that is a side surface portion in the interior of the casing 6. Both the guide and securing members 20 and 22 are made of resin. The guide member 20 is mounted to the casing 6, and guides the cable 5 which deforms within the interior of the accommodating space 1S with the movement of the image reading unit 3. As illustrated in FIG. 9A, the guide member 20 includes a guide surface 20a with which the first surface 5es of the cable 5 is brought into contact, and a guide projecting portion 24. The guide projecting portion 24 is a rib that is formed to project from the guide surface 20a below the cable 5, which is guided, and, by restricting the deformation of the cable 5 in the downward direction, restricts a position of the cable 5 in the width direction 112 of the cable 5. In this embodiment, the guide projecting portion 24 is formed only on the downward side of the cable 5, and not formed on an upward side of the cable 5. The guide projecting portion 24 can at least restrict the downward movement of the cable 5 due to its own weight. By forming the guide projecting portion 24 only on the downward side of the cable 5 as described above, workability during the routing of the cable 5 is enhanced. While the guide projecting portion is not disposed on a side in the upward direction U of the guide member 20, the present disclosure is not so limited.

As illustrated in FIG. 7, a secured portion 50, which is a portion between the first and second terminal portions 5a and 5b in the cable 5, is secured to the securing member 22. That is, the secured portion 50 is an example of a portion that is secured to the securing member 22 in the cable 5. In this embodiment, the secured portion 50 of the cable 5 is secured to the securing member 22 by means of double-sided tape 119, e.g. adhesive tape. A retaining plate 23 is mounted to the securing member 22 to prevent the detachment of the double-sided tape, and the securing member 22 and the retaining plate 23 are arranged to clamp the cable 5.

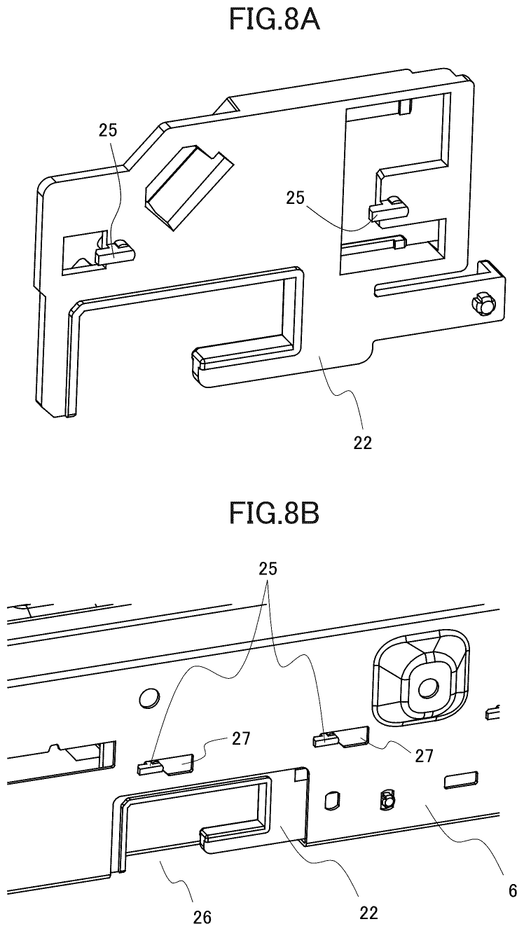

The securing member 22 is configured to be removed and mounted with respect to the image reading apparatus 1 with the cable 5 and the retaining plate 23 integrally secured. Therefore, since detachment is also possible, maintenance operations can be performed easily. The securing member 22 is not limited to being removed, and may be configured to be non-removable once mounted. As illustrated in FIG. 8A, claw portions 25 are disposed on a surface of the securing member 22 opposing the side wall 6a of the casing 6. As illustrated in FIG. 8B, hole portions 27 are formed in the side wall 6a of the casing 6, and the securing member 22 can be mounted to the casing 6 by sliding the claw portions 25 to engage with the hole portions 27. In a state in which the securing member 22 is mounted to the casing 6, the cable 5 is connected to the controller board 90 of the image forming apparatus 10 by being bent from the secured portion 50 toward the exterior of the casing 6, being arranged to pass through an opening portion 26 of the side wall 6a, and being routed to an outside of the casing 6.

As described above, the securing member 22 can be mounted to the image reading apparatus 1 in a state of being integrated with the cable 5. Thus, when assembling the image reading apparatus 1, after mounting the guide member 20 to the casing 6, it is possible to mount the securing member 22, which is integrated with the cable 5, to the casing 6. That is, an operation of securing the cable 5 to the casing can be performed not by mounting the cable 5 to the securing member 22 after the securing member 22 has been mounted to the casing 6, but by mounting the securing member 22, with the cable 5 mounted externally beforehand to the casing 6. In this case, as a manufacturing method for the image reading apparatus 1, there are steps of mounting the guide member 20 to the casing 6, mounting the cable 5 to the securing member 22 externally of the image reading apparatus 1, and mounting the securing member 22, with the cable 5 mounted, to the casing 6. Thereby, workability for mounting the cable 5 is enhanced, and mounting accuracy can be improved.

Here, such cables are configured such that, while both end portions are held by connectors or the like, intermediate portions frequently remain in a free state; in such cases, the cables move in a curved manner while following the movement of one or more image reading units. Depending on the posture or positions of the cables during the movement of the one or more image reading units, there is a risk that the cables may become entangled with the one or more moving image reading units. In this case, there is a possibility that the one or more image reading units may fail to operate properly, and scanning errors may occur. In contrast, a configuration is known in which a guide member for restricting the posture and position of a cable is mounted in an interior of a casing of an image reading apparatus. In this image reading apparatus, a guide portion is disposed in the guide member to maintain the posture and position of the cable in a desired state; thereby, the cable is prevented from being entangled with the image reading unit 3 due to improper posture. Since, during assembly of the image reading apparatus, the cable is secured to the guide member that has been mounted to the casing, it is necessary to perform an operation while looking into the casing when mounting the cable; thus, workability is deficient. As a result, there is a risk that the cable may be mounted at an oblique angle from its predetermined position with respect to the guide member. Thus, assembly errors, such as the cable climbing up on the guide member, may occur, and may impair the mounting accuracy of the cable. In other words, in a case where the guide member 20 and the securing member 22 constitute an integral component, when attempting to mount the integrated component, with the cable 5 previously mounted, to the casing 6, it becomes necessary to simultaneously perform both operations of mounting the integrated component and routing the cable 5. As a result, there is a risk that the workability may be deficient and the mounting accuracy may be impaired. In contrast, according to this embodiment, since the guide member 20 and the securing member 22 are configured as separate members, it is possible to perform the operations of mounting the guide member 20 and routing the cable 5 as separate operations; therefore, it is possible to enhance the workability and improve the mounting accuracy.

In this embodiment, the securing member 22 is mounted to overlap the opening portion 26 when viewed in an opening direction 115 of the opening portion 26, with the securing member 22 not being required to overlap the opening portion 26. As illustrated in FIG. 3B, in the sub-scanning direction D1 (left-right direction), the securing member 22 is arranged at a position closer to the opening portion 26 than the guide member 20. When a distance between the guide member 20 and the opening portion 26 in the sub-scanning direction D1 (L1), and a distance between the securing member 22 and the opening portion 26 in the sub-scanning direction D1 (L2), then L1>L2. That is, the securing member 22 is mounted at a position at which the distance L2 from the securing member 22 to the opening portion 26 is shorter than the distance L1 between the guide member 20 and the opening portion 26. In this embodiment, since the securing member 22 overlaps the opening portion 26, L2=0 when viewed in the opening direction 115 of the opening portion 26. As described above, by arranging the securing member 22 at the position closer to the opening portion 26 than the guide member 20, it becomes possible to easily perform an operation of passing the cable 5 through the opening portion 26 in conjunction with mounting the securing member 22 to the casing 6.

In the cable 5, the width direction 112 of the cable 5 intersects with respect to the upper surface of the platen glass 2 in an intermediate portion between a portion secured to the side wall 6a and a portion held by the image reading unit 3. In the intermediate portion, the inner and outer cables 5d and 5e are arranged so as to overlap in their thickness direction 114. In the intermediate portion, in a state in which the cable 5 is guided by the guide member 20, in the main scanning direction D2 of the image reading unit 3, the outer cable 5e is arranged on a side adjacent to the side wall 6a of the casing 6, and the inner cable 5d is arranged on a far side (inner side of the casing 6). That is, in the state in which the cable 5 is guided by the guide member 20, the cable 5 is arranged such that inner cable 5d is disposed further inside the casing 6 than the outer cable 5e is disposed inside the casing 6.

In addition, as illustrated in FIG. 9A, in the guide member 20, a sheet member 21 formed from silicone rubber is adhered at a portion with which the outer cable 5e comes into contact, so as to suppress the slippage in the longitudinal direction of the outer cable 5e. That is, the guide surface 20a of the guide member 20 includes the sheet member 21 that forms a high friction coefficient region having a higher friction coefficient than that of low friction portions of the guide member 20. Here, low friction portions refers to portions possessing a lower friction coefficient than that of the high friction region, such as the guide surface 20a in a case of being assumed as a planar surface, a surface of the guide projecting portion 24, and a surface opposite to the guide surface 20a of the guide member 20. In addition, the sheet member 21 possesses a higher friction coefficient than that of the low friction portions, and is adhered to the guide surface 20a. The sheet member 21 is not limited to being made of silicone rubber, but may be made of any material having a higher friction coefficient than that of the low friction portions of the guide member 20 and the side wall 6a of the casing 6. For example, a sheet member to which slightly tacky pressure sensitive adhesives are applied may also be employed.

In addition, as illustrated in FIG. 9B, instead of the sheet member 21, it is acceptable to provide a configuration in which the guide member 20 is provided with a surface irregularity treatment to form an uneven portion 20b, so that the slippage in the longitudinal direction of the cable 5 is suppressed in the uneven portion 20b. That is, the high friction coefficient region is constituted by the uneven portion 20b formed on the guide surface 20a. Further, it is acceptable to suppress the slippage in the longitudinal direction of the cable 5 by adopting materials with a high friction coefficient as a material for the guide member 20.

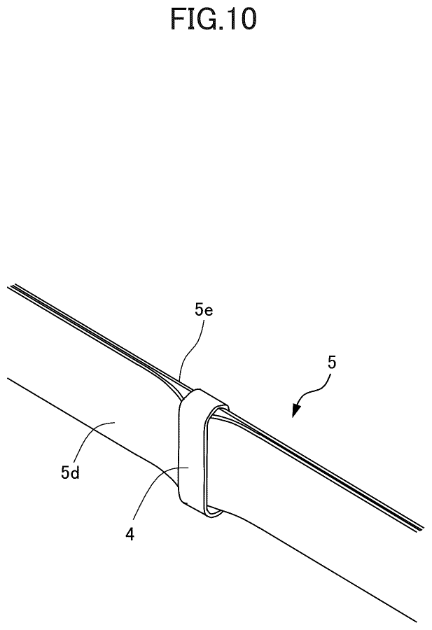

In addition, as illustrated in FIGS. 9A and 10, in the cable 5, a regulatory member 4 for restraining the inner and outer cables 5d and 5e which overlap in the thickness direction 114 is attached at the intermediate portion between the portion secured to the side wall 6 and the portion held by the image reading unit 3. That is, the regulatory member 4 is attached between the first terminal portion 5a and the secured portion 50 in the cable 5. The regulatory member 4 restricts the separation in the thickness direction 114 of the inner and outer cables 5d and 5e, and allows relative movement in a direction perpendicularly intersecting the width and thickness directions 112, 114 of the cable 5. The regulatory member 4 is adhered and secured to the inner cable 5d using adhesive tape, comes into contact with the outer cable 5e without being secured to it, and restrains the inner and outer cables 5d and 5e by winding around them. Thereby, the regulatory member 4 allows the relative movement in the longitudinal direction of the inner and outer cables 5d and 5e, and restricts the relative movement in the width and thickness directions 112, 114.

As described above, according to this embodiment, the guide and securing members 20 and 22 are separate members, and the cable 5 is secured to the securing member 22. Thereby, it becomes possible to mount the securing member 22, to which the cable 5 is secured, to the casing 6, and, since the workability to mount the cable 5 is enhanced, it is possible to improve the mounting accuracy.

In addition, according to this embodiment, since the securing member 22 is arranged at the position closer to the opening portion 26 than the guide member 20, it becomes possible to easily pass the cable 5 through the opening portion 26 while mounting the securing member 22 to the casing 6.

While in the embodiment described above, the cable 5 has the configuration that is folded in two around the slit 5c, it is not limited to this, and a flexible flat cable that is not folded in two as described above may also be employed. Alternatively, so long as it is a flexible cable having flexibility, cables that do not possess a flat configuration can also be applied.

In the embodiment described above, the guide and securing members 20 and 22 are mounted to the side wall 6a, which partitions the interior and exterior of the casing 6; however, it is not limited to this. For example, a side wall disposed in the casing 6 may partition the interior of the casing 6 into a space for the movement of the image reading unit 3 (accommodating space 1S) and a backward space with respect to the accommodating space 1S. In this case, the guide and securing members 20 and 22 can be mounted to such a side wall. In addition, in this case, the board to which the cable 5 is connected may be arranged in the backward space.

In addition, in the embodiment described above, the image forming unit 104 is described as utilizing the electrophotographic system; however, it is not limited to this, and an inkjet recording system may also be employed.

According to this embodiment, it is possible to improve the mounting accuracy of the cable with respect to the casing.

### Second Embodiment

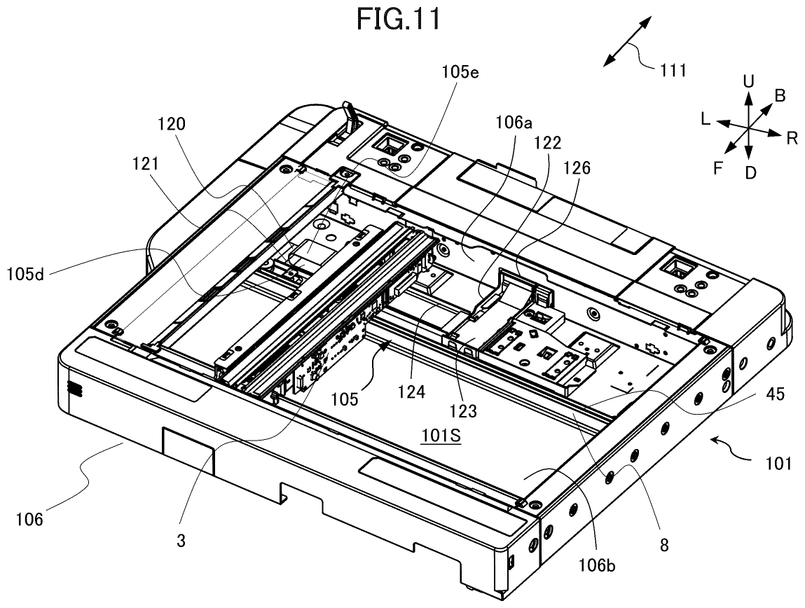

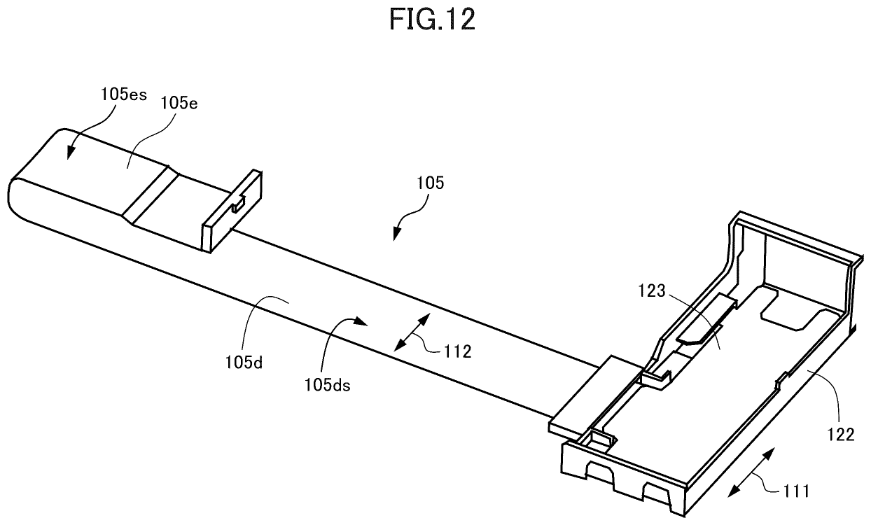

The second embodiment will be described making reference to FIGS. 11 and 12. This embodiment differs in configuration from the first embodiment in that a width direction 112 of a cable 105 is arranged horizontally instead of vertically. In an image reading apparatus 101 of this embodiment, the width direction 112 of the cable 105 is arranged horizontally in an accommodating space 101S, and a guide member 120 and a securing member 122 are mounted to a bottom surface portion 106b of a casing 106. However, the other configurations are identical to those of the first embodiment; therefore, the same reference characters are used, the detailed description of which is incorporated herein by reference.

FIG. 11 is a perspective view illustrating the image reading apparatus 101. FIG. 12 is a perspective view illustrating the cable 105 and the securing member 122. The cable 105 has a flat configuration including a first surface 105es and a second surface 105ds opposite to the first surface 105es. The cable 105 is arranged to align the width direction 112 of the first surface 105es and the second surface 105ds with a horizontal direction 111 and a width direction 112 of the first and second surfaces 105es and 105ds is arranged horizontally. In particular, in this embodiment, the width direction 112 of the first and second surfaces 105es and 105ds is arranged to be aligned with the main scanning direction D2. As illustrated in FIG. 11, on the bottom surface portion 106b of the casing 106, the guide member 120, which restricts movement in the width direction 112 of the cable 105, and the securing member 122, which secures the cable 105, are disposed. The guide and securing members 120 and 122 are made of resin.

The guide member 120 includes a guide surface, with which the first surface 105es of the cable 105 is brought into contact, and a pair of guide projecting portions 124. The pair of guide projecting portions 124 are formed to project from the guide surface on both sides in the width direction 112 of the cable 105, which is guided, and restrict deformation in the width direction 112 of the cable 105. The cable 105 includes the secured portion 50 that is secured to the securing member 122 by means of double-sided tape. In addition, a retaining plate 123 is mounted to the securing member 122 to prevent the detachment of the double-sided tape, and the cable 105 is arranged to be clamped between the securing member 122 and the retaining plate 123.

As illustrated in FIG. 12, the securing member 122 can be removably mounted with respect to the image reading apparatus 101 in a state of being integrated with the cable 105 and the retaining plate 123. In addition, the cable 105 passes through an opening portion 126 of a side wall 106a by being bent from the secured portion, and is connected to the controller board 90 by being routed to the outside of the casing 106. The securing member 122 is arranged at a position closer to the opening portion 126 than the guide member 120.

In the cable 105, an intermediate portion between a portion secured to the bottom surface portion 106b and a portion held by the image reading unit 3 is arranged such that the width direction 112 of the cable 105 is arranged parallel to the upper surface of the platen glass 2. In the intermediate portion, inner and outer cables, 105d and 105e, respectively, are arranged to overlap in their thickness direction 114. Here, in the intermediate portion, in the main scanning direction D2 of the image reading unit 3, the outer cable 105e is arranged on a side adjacent to the bottom surface portion 106b of the casing 106, and the inner cable 105d is arranged on a far side. In addition, in the guide member 120, a sheet member 121 formed of silicone rubber is adhered at a portion with which the outer cable 105e comes into contact, so as to suppress slippage in a longitudinal direction of the outer cable 105e.

As described above, according to this embodiment, the guide and securing members 120 and 122 are separate members, and the cable 105 is secured to the securing member 122. Thereby, it becomes possible to mount the securing member 122, to which the cable 105 is secured, to the casing 106, and, since workability to mount the cable 105 is enhanced, it is possible to improve mounting accuracy.

In addition, according to this embodiment, since the securing member 122 is arranged at the position closer to the opening portion 126 than the guide member 120, it becomes possible to easily perform an operation of passing the cable 105 through the opening portion 126 in conjunction with mounting the securing member 122 to the casing 106.

### Third Embodiment

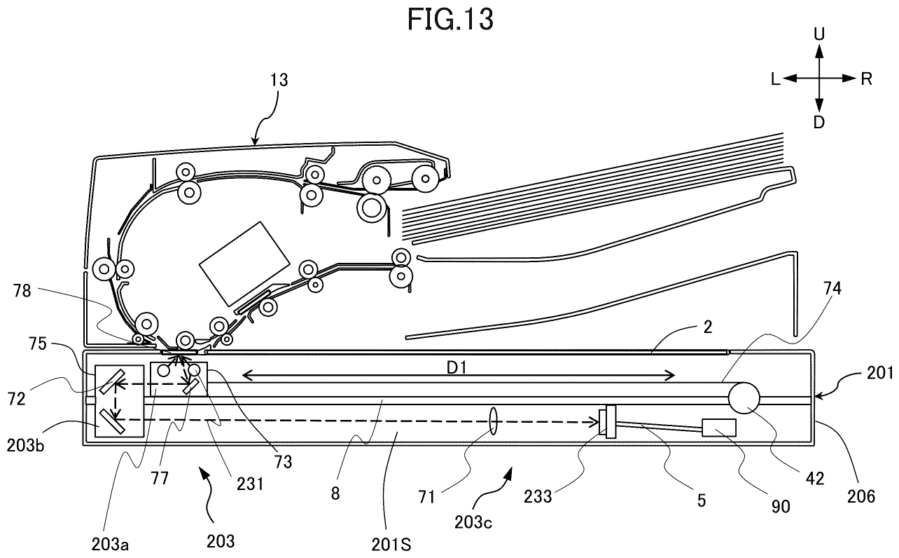

A third embodiment is described referring to FIG. 13. This embodiment differs in configuration from the first embodiment in that an image reading unit 203 employs a 1:2 reduction optical unit. However, the other configurations are identical to those of the first embodiment, regarding which the same reference characters are used, and the detailed description is incorporated herein by reference, for conciseness.

FIG. 13 is a schematic cross-sectional view illustrating a configuration of an image reading apparatus 201 including the image reading unit 203 constituted by the 1:2 reduction optical unit. The image reading apparatus 201 includes a casing 206, the platen glass 2, and the image reading unit 203. An image reading unit 203 is accommodated in an accommodating space 201S, and includes a first unit 203a, a second unit 203b, a stationary unit 203c, the motor 42, and a belt 74. The first unit 203a includes a first unit case 73, which can move in the sub-scanning direction D1, a light emitting element 231, which irradiates light onto the image of the document placed on the platen glass 2, and a first mirror portion 77, which reflets reflected light reflected from the image of the document. The light emitting element 231 and the first mirror portion 77 are accommodated in the first unit case 73. The first unit 203a is an example of the moving unit. Therefore, a cable for supplying an electrical signal to activate the light emitting element 231 of the first unit 203a is connected to the first unit 203a. The first mirror portion 77 includes, for example, one reflecting mirror.

The second unit 203b includes a second unit case 75, which can move in the sub-scanning direction D1 and moves half a distance in the same direction as the first unit case 73, and a second mirror portion 72. The second mirror portion 72 is accommodated in the second unit case 75, and reflects reflected light of the image reflected from the first mirror portion 77. The second mirror portion 72 includes, for example, two reflecting mirrors.

The stationary unit 203c is mounted to the casing 206, and does not move. The stationary unit 203c includes a lens 71, which transmits reflected light of the image reflected by the second mirror portion, and a light receiving element 233, which receives the light transmitted through the lens 71 and converts it into an electrical signal. The light receiving element 233 is constituted by, for example, a CCD.

In an interior of the image reading apparatus 201, the guide shaft 8 extending in the sub-scanning direction D1 of the image reading unit 203 is disposed, and the first and second units 203a and 203b are loosely and movably fitted onto the guide shaft 8. The first unit 203a is connected to the motor 42 through the belt 74. The second unit 203b is configured to move half a moving amount in the same direction as the first unit 203a by means of a deceleration mechanism.

When the motor 42 is driven through an instruction of the CPU mounted on the controller board 90, the first and second units 203a and 203b are moved in the sub-scanning direction D1 by a movement mechanism using the motor 42 and the belt 74, while being guided by the guide shaft 8. When the first unit 203a is moved, the light irradiated from the light emitting element 231 is scanned in the sub-scanning direction D1 toward the document on the platen glass 2. The light emitting element 231 includes numerous light sources arrayed along the main scanning direction D2, and irradiates one line of light toward the document positioned at a document reading position 78 on the platen glass 2.

The document reading position 78 moves in the sub-scanning direction D1 in accordance with the movement of the first unit 203a. The first mirror portion 77 reflects the reflected light, which is generated when the light emitting element 231 irradiates the light toward the document positioned at the document reading position 78, toward the second mirror portion 72. The reflected light is incident on the lens 71 through the second mirror portion 72. The lens 71 converges the incident light and causes it to be incident on the light receiving element 233. The light receiving element 233 is a photoelectric conversion element that converts received light into an electrical signal and outputs the electric signal as image data. The image data output from the light receiving element 233 is transmitted to the controller board 90 via the cable 205, and image processing is performed by an electronic component mounted on the controller board 90.

In this embodiment, the image reading apparatus 201 includes a guide member that guides a cable connecting the movable first unit 203 and the controller board 90 and deforms with the movement of the first unit 203, and a securing member that secures this cable. These guide and securing members have configurations identical to those of the first or second embodiment, regarding which the detailed description is incorporated herein by reference, for conciseness.

As described above, also in this embodiment, similar to the first and second embodiments, the guide and securing members are separate members, and the cable is secured to the securing member. Thereby, it becomes possible to mount the securing member, to which the cable is secured, to the casing 206, and workability for mounting the cable is enhanced; therefore, it is possible to improve mounting accuracy.

In addition, according to this embodiment, it can also be applied to the image reading unit 203 constituted by the 1:2 reduction optical unit; therefore, the scope of the application of this configuration can be expanded.

### Fourth Embodiment

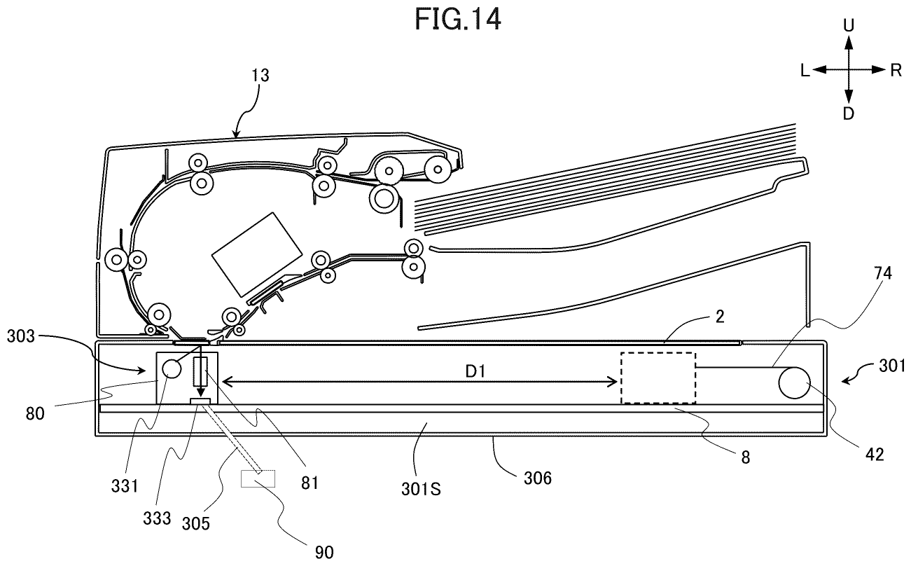

A fourth embodiment is described referring to FIG. 14. This embodiment differs in configuration from the first embodiment in that an image reading unit 303 is constituted as a contact image sensor (CIS) unit, which is a contact optical system. However, the other configurations are identical to those of the first embodiment, the same reference characters are used, and the detailed description is incorporated herein by reference, for conciseness.

FIG. 14 is a schematic cross-sectional view illustrating a configuration of an image reading apparatus 301 including the CIS unit. The image reading apparatus 301 includes a casing 306, the platen glass 2, and the image reading unit 303. The image reading unit 303 is the CIS unit, is accommodated in an accommodating space 301S, and includes a case 80, a light emitting element 331, a lens array 81, and a light receiving element 333. The light emitting element 331 is disposed to irradiate a line-shaped light extending in the main scanning direction D2 toward the document on the platen glass 2. The light receiving element 333 is a linear image sensor constituted by a plurality of light receiving elements arranged in the main scanning direction D2, and is disposed such that its front-back direction is aligned with the main scanning direction D2.

In an interior of the image reading apparatus 301, the guide shaft 8 extending in the sub-scanning direction D1 of the image reading unit 303 is disposed, and the image reading unit 303 is loosely and movably fitted onto the guide shaft 8. The image reading unit 303 is connected to the motor 42 through the belt 74. When the motor 42 is driven through an instruction of the CPU mounted on the controller board 90, while being guided by the guide shaft 8, the image reading unit 303 is moved in the sub-scanning direction D1 by a movement mechanism using the motor 42 and the belt 74.

When the image reading unit 303 is moved, light is irradiated from the light emitting element 331 toward the document on the platen glass 2. The light reflected on the surface of the document passes through the lens array 81, and is incident on the light receiving element 333. The light incident on the light receiving element 333 is converted into an electrical signal, and is output as image data. The image data output from the light receiving element 333 is transmitted to controller board 90 via a cable 305, and image processing is performed by an electronic component mounted on the controller board 90.

In this embodiment, the image reading apparatus 301 includes a guide member that guides the cable 305, which connects the movable image reading unit 303 and the controller board 90 and deforms with the movement of image reading unit 303, and a securing member that secures this cable 305. These guide and securing members have configurations identical to those of the first and second embodiments, the detailed description of which is incorporated herein by reference, for conciseness.

As described above, also in this embodiment, similar to the first and second embodiments, the guide and securing members are separate members, and the cable is secured to the securing member. Thereby, it becomes possible to mount the securing member, to which the cable is secured, to the casing 306, and workability for mounting the cable is enhanced; therefore, it is possible to improve mounting accuracy.

In addition, according to this embodiment, it is possible to apply to the image reading unit 303 constituted by the CIS unit; therefore, the scope of the application of this configuration can be expanded.

### Other Embodiments

While the present disclosure has been described with reference to embodiments, it is to be understood that the disclosed embodiments are provided as examples and the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-004746, filed Jan. 14, 2025 which is hereby incorporated by reference herein in its entirety.

1. An image reading apparatus comprising:
a casing including an opening portion;
a transparent plate mounted to the casing;
a moving unit accommodated in an accommodating space formed by the casing and the transparent plate and configured to move in a sub-scanning direction to read an image on or adjacent to the transparent plate by performing a scan in a main scanning direction;
a cable including a first terminal portion connected to the moving unit and a second terminal portion connected to a board arranged outside the accommodating space, the cable being arranged to pass through the opening portion;
a guide member mounted to the casing and configured to guide the cable that deforms in an interior of the accommodating space with movement of the moving unit; and
a securing member, wherein:
the cable is secured to the securing member between the first terminal portion and the second terminal portion, and
the securing member is mounted to the casing in the interior of the accommodating space at a distance from the opening portion that is shorter than a distance between the guide member and the opening portion.

2. The image reading apparatus according to claim 1, wherein the securing member is removably mounted with respect to the casing in a state in which the cable is secured to the securing member.

3. The image reading apparatus according to claim 2,
wherein the securing member includes at least one claw portion,
wherein the casing includes at least one hole portion configured to removably engage with the at least one claw portion, and
wherein the securing member is removably mounted to the casing by engagement of the at least one claw portion with the at least one hole portion.

4. The image reading apparatus according to claim 1, wherein the securing member is mounted to overlap the opening portion, viewed in an opening direction of the opening portion.

5. The image reading apparatus according to claim 4, wherein, in a state in which the securing member is mounted to casing, the cable is bent from the portion secured to the securing member toward an exterior of the casing, is arranged to pass through the opening portion, and is routed outside of the casing.

6. The image reading apparatus according to claim 1, wherein the cable is secured with respect to the securing member with adhesive tape.

7. The image reading apparatus according to claim 1,
wherein the cable has a flat configuration including a first surface and a second surface opposite to the first surface, and is arranged to align a width direction of the first surface and the second surface with a vertical direction,
wherein the guide member includes a guide surface configured to contact the first surface, and a guide projecting portion projecting from the guide surface below the cable, and
wherein the guide projecting portion is configured to restrict deformation of the cable in a downward direction.

8. The image reading apparatus according to claim 1, wherein the guide member and the securing member are mounted to an interior side surface portion of the casing.

9. The image reading apparatus according to claim 1,
wherein the cable has a flat configuration including a first surface and a second surface opposite to the first surface, and is arranged to align a width direction of the first surface and the second surface with a horizontal direction,
wherein the guide member includes a guide surface configured to contact the first surface, and a pair of guide projecting portions projecting from the guide surface on both sides in a width direction of the cable, and
wherein the pair of guide projecting portions are configured to restrict deformation of the cable in the width direction.

10. The image reading apparatus according to claim 1, wherein the guide member and the securing member are mounted to an interior bottom surface portion of the casing.

11. The image reading apparatus according to claim 1,
wherein the casing is made of metal, and
wherein the guide member and the securing member are made of resin.

12. The image reading apparatus according to claim 1,
wherein the cable:
has a flat configuration;
includes a plurality of conductor wires including a first conductor wire and a second conductor wire electrically connecting the first terminal portion and the second terminal portion, a first portion including the first conductor wire, a second portion including the second conductor wire, and a slit disposed between the first portion and the second portion; and
is bent at the slit such that portions of the first portion and the second portion are overlapped, viewed in a thickness direction of the cable.

13. The image reading apparatus according to claim 12,
wherein, in a state of being guided by the guide member, more of the first portion is inside the casing than the second portion,
wherein the guide member includes a guide surface configured to guide the second portion of the cable, and
wherein the guide surface includes a high friction coefficient region that has a higher friction coefficient than that of a low friction portion in the guide member.

14. The image reading apparatus according to claim 13, wherein the high friction coefficient region is formed by a sheet member that has a higher friction coefficient than that of the low friction portion and is adhered to the guide surface.

15. The image reading apparatus according to claim 14, wherein the sheet member is made of silicone rubber.

16. The image reading apparatus according to claim 13, wherein the high friction coefficient region is constituted by an uneven portion formed on the guide surface.

17. The image reading apparatus according to claim 12, further comprising:
a regulatory member mounted between the first terminal portion and a portion secured to the securing member in the cable,
wherein the regulatory member is configured to restrict separation in the thickness direction of the first portion and the second portion while allowing relative movement in a direction intersecting a width direction and the thickness direction.

18. The image reading apparatus according to claim 1, further comprising:
an image reading unit including a light emitting element configured to irradiate light onto a document containing the image with the document placed on the transparent plate, and a light receiving element configured to receive reflected light from the image of the document and convert the reflected light into an electrical signal, and
wherein the light emitting element and the light receiving element constitute the moving unit.

19. The image reading apparatus according to claim 1, further comprising:
an image reading unit including a light emitting element configured to irradiate light onto a document containing the image with the document placed on the transparent plate, and a light receiving element configured to receive reflected light from the image of the document and convert the reflected light into an electrical signal,
wherein the light emitting element is mounted to the moving unit, and
wherein the light receiving element is mounted to the casing.

20. An image forming apparatus comprising:
the image reading apparatus according to claim 1; and
an image forming unit configured to form an image on a sheet.
